(19) United States
(12) Patent Application Publication
(10) Pub. No.: US 2008/0072107 A1
(43) Pub. Date: Mar. 20, 2008

(54) APPARATUS AND METHOD FOR DETECTING ERRORS IN DISPLAY DRIVER INTEGRATED CIRCUIT OF MOBILE DEVICE

(75) Inventors: Won-Bae JUNG, Suwon-si (KR); Hyung Wook Jang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/833,059

(22) Filed: Aug. 2, 2007

(30) Foreign Application Priority Data
Sep. 15, 2006 (KR) 2006-0089620

(51) Int. Cl. G06F 11/00

(52) U.S. Cl. 714/57; 714/E11.001

(57) ABSTRACT

Disclosed are an apparatus and a method for detecting errors in a display driver IC to prevent abnormal phenomena in a display unit of a mobile device. When initializing a memory of the display driver IC, a control unit stores control values in the memory for controlling a liquid crystal panel. An error detector checks the control values in the memory and outputs a detection value depending on a change of the control values in the memory. The control unit receives the detection value from the error detector and initializes again the memory when the received detection value is unusual. The apparatus and method use hard-wired lines for interconnection and interrupt instructions for error detection.

### PRIORITY

This U.S. non-provisional application claims priority under 35 U.S.C. §119 to Korean Patent Application No. 2006-89620, which was filed in the Korean Intellectual Property Office on Sep. 15, 2006, the content of which is incorporated by reference herein.

### BACKGROUND OF THE INVENTION

1. Field of the Invention

The present invention relates generally to error detection in a display unit of a mobile device and, more particularly, to an apparatus and a method for detecting errors in a display driver Integrated Circuit (IC) to prevent abnormal phenomena in a display unit of a mobile device.

2. Description of the Related Art

In a mobile device such as a mobile phone and a Personal Digital Assistant (PDA), a display unit is an end part that presents, in a visual form, information created or processed during operation of the mobile device. Thus a user may come in contact with the display unit directly and most frequently. Contrary to defects in any other unit of the mobile device, abnormalities of the display unit may be immediately recognized by a user. Therefore, the display unit is one of the factors that most influences the satisfaction of a user.

As well known, the display unit of the mobile device employs in general a Liquid Crystal Display (LCD), which is composed of a liquid crystal panel and an LCD driver IC (LDI). The operation of the liquid crystal panel is controlled by the LDI. So if there occurs any error in the LDI, unexpected abnormalities are often incurred to the liquid crystal panel and ultimately to the display unit. Well-known abnormalities of the display unit may be whitening, blacking, and other unusual phenomena. Such abnormalities may occur depending on variations of memory values in the LDI due to electrostatic discharge (ESD), a physical shock, a sudden change in temperature, etc.

In order to solve the above issue related to the occurrence of error occurrence in the LDI, a conventional method initializes a memory of the LDI whenever the mobile device is powered or whenever a folder or a slider is opened or closed. This method may, however, fail to detect an abnormality that unexpectedly occurs in use of the mobile device.

Another conventional method checks a memory of the LDI at regular intervals to detect an abnormality occurring in use. FIG. 1 illustrates, in a flow diagram, such a conventional method.

Referring to FIG. 1, in step 11 a control unit of a mobile device initializes a memory of the LDI. Then, in step 12 the control unit reads memory values stored in the memory, and in step 13 compares the memory values with predetermined reference values. Additionally, in step 14 the control unit determines whether a predefined time elapses after the memory-reading step 12. When the memory values agree with the reference values and also the predefined time elapses, the control unit performs again the memory-reading step 12. If the memory values disagree with the reference values, the control unit initializes again the memory in step 15.

Such a conventional method can detect abnormalities unexpectedly occurring in use of the mobile device since the control unit checks the memory of the LDI at periodic intervals by use of a micro-program. However, this method may have a drawback in that the control unit has heavy burdens of reading the memory values, comparing the memory values with the reference values, and re-initializing the memory. Additionally, this method may result in a delay of error detection due to an interval of time between two memory-reading steps.

### SUMMARY OF THE INVENTION

The present invention reduces a burden of a control unit and improves a speed of error detection when detecting errors in a display driver IC of a mobile device.

Error detection apparatus and method according to the present invention enable a display driver IC to execute error detection. Moreover, for error detection, the apparatus and method of the present invention use a hard-wired manner instead of a typical micro-program manner and further use an interrupt manner instead of a typical periodic checking manner.

According to an aspect of the present invention, an apparatus for detecting errors in a display driver integrated circuit of a mobile device includes a memory storing control values for controlling a liquid crystal panel; an error detector connected to the memory, the error detector checking the control values in the memory and outputting a detection value as check results; and a control unit connected to the error detector to receive the detection value from the error detector, the control unit executing a re-initialization process for the memory when the received detection value is unusual.

In this apparatus, the memory and the error detector are preferably included together within the display driver integrated circuit. The memory and the error detector are preferably connected through a hard-wired line. The error detector and the control unit are preferably connected through a pin on which the detection value is loaded.

In an embodiment of the present invention, the error detector includes an accumulator connected to a memory identification address of the memory, the accumulator calculating a sum of bits recorded in the memory identification address to output the sum as the detection value. Here, the accumulator may have an inverter that keeps the detection value to be uniform regardless of the control values in the memory.

Alternatively, the error detector includes an encoder connected to a memory identification address of the memory, the encoder converting a series of bits recorded in the memory identification address into a predefined code to output the code as the detection value. In this case, the error detector further includes first and second embedded memories selectively connected to the encoder, and a comparator connected to the first and second embedded memories, the first embedded memory storing the detection value, the second embedded memory storing a reference value, and the comparator comparing the detection value with the reference value and then transmitting a comparison result to the control unit.

Alternatively, the error detector includes an encoder connected to every address of the memory, the encoder converting a series of bits recorded in each address into a predefined code to output the code as the detection value. In this case, the error detector further includes first and second embedded memories selectively connected to the encoder, and a comparator connected to the first and second embedded memories, the first embedded memory storing the detection value, the second embedded memory storing a reference value, and the comparator comparing the detection value with the reference value and then transmitting a comparison result to the control unit.

According to another aspect of the present invention, a method for detecting errors in a display driver integrated circuit of a mobile device, includes initializing a memory of the display driver integrated circuit by storing control values in the memory for controlling a liquid crystal panel; outputting a detection value depending on a change of the control values in the memory; transmitting the detection value to a control unit; and re-initializing the memory when the detection value is unusual.

In this method, the transmitting of the detection value preferably includes loading the detection value on a pin connected to the control unit.

The outputting of the detection value preferably includes calculating a sum of bits recorded in a memory identification address of the memory, and outputting the sum as the detection value. Here, the outputting of the detection value may further include keeping the detection value to be uniform regardless of the control values in the memory.

The initializing of the memory preferably includes storing a reference value regarding a memory identification address of the memory. In this case, the outputting of the detection value preferably includes converting a series of bits recorded in the memory identification address into a predefined code, comparing the code with the reference value, and outputting a comparison result as the detection value.

Alternatively, the initializing of the memory includes storing reference values regarding every address of the memory. In this case, the outputting of the detection value may include converting a series of bits recorded in each address into a predefined code, comparing each code with the corresponding reference value, and outputting a comparison result as the detection value.

### BRIEF DESCRIPTION OF THE DRAWINGS

The objects, features and advantages of the present invention will be more apparent from the following detailed description in conjunction with the accompanying drawings, in which:

FIG. 1 is a flow diagram illustrating a conventional method of detecting errors in a display driver IC of a mobile device;

FIG. 2 is a block diagram illustrating an apparatus and a method for detecting errors in a display driver IC of a mobile device in accordance with the present invention;

FIGS. 3A and 3B are schematic views illustrating an apparatus and a method for detecting errors in a display driver IC of a mobile device in accordance with an exemplary embodiment of the present invention;

FIGS. 4A and 4B are schematic views illustrating an apparatus and a method for detecting errors in a display driver IC of a mobile device in accordance with another exemplary embodiment of the present invention; and

FIGS. 5A and 5B are schematic views illustrating an apparatus and a method for detecting errors in a display driver IC of a mobile device in accordance with still another exemplary embodiment of the present invention.

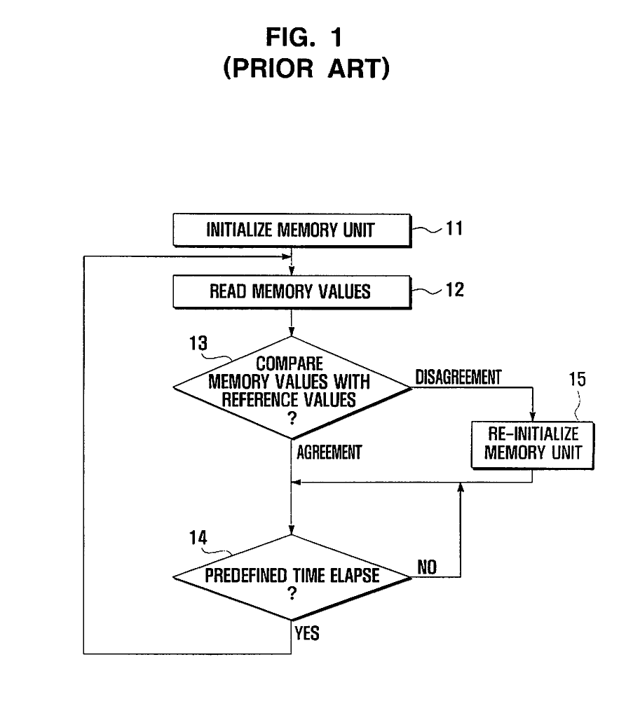

### DETAILED DESCRIPTION OF THE PREFERRED EMBODIMENTS

Exemplary, non-limiting embodiments of the present invention will now be described more fully hereinafter with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Well-known structures and processes are not described or illustrated in detail to avoid obscuring the essence of the present invention. Like reference numerals are used for like and corresponding parts of the various drawings.

A mobile device to which the present invention is favorably applied includes a great variety of mobile phones of third-generation or fourth-generation, Personal Digital Assistants (PDAs), smart phones, various types of multimedia players such as an MP3 player, and other electronic portable devices having a display unit. Herein, the display unit may be, but is not limited to, a Liquid Crystal Display (LCD). The following embodiments may be applied to the above-listed respective devices.

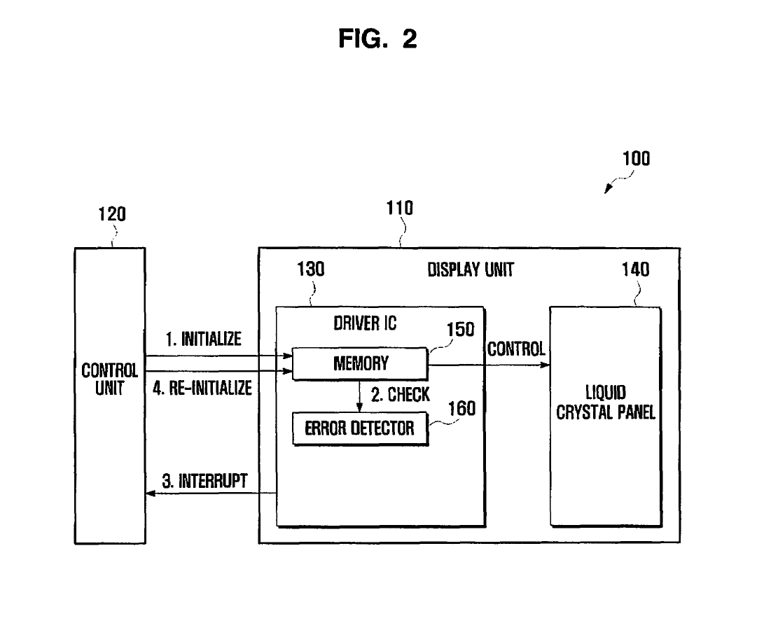

Referring to FIG. 2, an error detection apparatus 100 includes a display unit 110 and a control unit 120. The display unit 110 has a driver IC 130 and a liquid crystal panel 140. In addition, the driver IC 130 has a memory 150 and an error detector 160.

The liquid crystal panel 140 of the display unit 110 operates under the control of the driver IC 130. The control unit 120 stores control values into the memory 150 of the driver IC 130 through an initialization process. The driver IC 130 controls the liquid crystal panel 140 by using the control values stored in the memory 150. Herein, the initialization process includes a reset, namely, a re-initialization, as well as a normal initialization. The normal initialization writes predetermined control values into the memory 150, whereas the reset is utilized to set again the memory 150 to a newly usable state.

The error detector 160 is connected to the memory 150 through a hard-wired line. The error detector 160 may be a register such as an accumulator. Alternatively, the error detector 160 may be a coder and a discriminator. The error detector 160 automatically checks the control values in the memory 150 and then outputs a detection value as check results. The detection value varies according to occurrence of errors in the memory 150. That is, when the control values in the memory 150 are changed due to a certain cause, the detection value is therefore changed to be unusual. The error detector 160 transmits the detection value to the control unit 120 through a pin 171, as described below.

The control unit 120 receives the detection value from the error detector 160. When the detection value is unusual, the control unit 120 regards the unusual value as an interrupt signal indicating that there were errors occurring in the memory 150. Therefore the control unit 120 executes a re-initialization process for the memory 150 through a control bus. The unusual value indicates a change of the detection value and is used by another detection value different from the one which is previously transmitted. For example, in case that two values, ‘0’ and ‘1’, are used as detection values, and at a previous process, the value, ‘1’, is transmitted to the control unit 120 as a normal state, the value ‘0’ becomes the unusual value.

As discussed hereinbefore, an error detection process is executed in the driver IC 130, whereas an initialization process is performed in the control unit 120. This division of processes favorably reduces a burden of the control unit 120. Additionally, the use of hard-wired lines and interrupt instructions improves the speed of error detection.

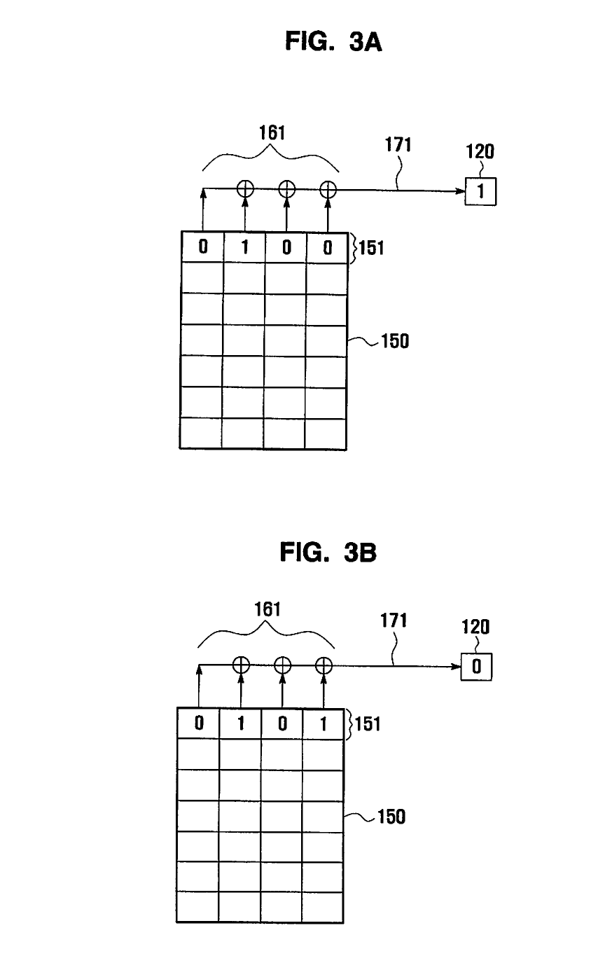

FIGS. 3A and 3B are schematic views that illustrate an apparatus and a method for detecting errors in a display driver IC of a mobile device in accordance with an exemplary embodiment of the present invention. FIG. 3A shows a normal state of the memory, and FIG. 3B shows an abnormal state of the memory.

Referring to FIG. 3A, the memory 150 of the driver IC contains a specific address 151 for recording memory identification (ID), which is a kind of control value. This specific address 151 is connected to an accumulator 161, a kind of register, used as the error detector. The accumulator 161 is coupled to the control unit 120 through the pin 171.

The accumulator 161 calculates a sum of bits recorded in the memory ID address 151. The sum of bits is ‘1 (high)’ or ‘0 (low)’, which is regarded as a detection value of the memory ID address 151. The detection value is loaded onto the pin 171 and transmitted to the control unit 120. In an example shown in FIG. 3A, the memory ID address 151 records a series of bits ‘0100’ as the memory ID, and the pin 171 carries a detection value of ‘1’.

When a series of bits recorded in the memory ID address 151 is changed as shown in FIG. 3B, a detection value detected by the accumulator 161 and loaded onto the pin 171 is also changed. When the detection value is changed, the control unit 120 becomes aware of the change and executes a re-initialization process for the memory 150.

In this embodiment, the memory 150 is connected to the accumulator 161 through a hard-wired line. Furthermore, the pin 171 through which the accumulator 161 is coupled to the control unit 120 is also a kind of hard-wired line. Therefore, the value in the memory ID address 151 is immediately detected through the accumulator 161 and always provided to the control unit 120 through the pin 171. This mechanism can allow faster error detection and can be easily realized without requiring additional memories. Furthermore, the change of the detection value acts as interrupt instructions for the control unit 120, so the control unit 120 can recognize and correct memory error as soon as errors occur.

If necessary, an inverter (not shown) may be added to the accumulator 161. When the memory 150 is in a normal state, the detection value loaded on the pin 171 may be ‘1’ or ‘0’ according to the control values recorded in the memory 150. However, if the inverter is used properly, it is possible to always transmit a uniform value to the control unit 120 regardless of the control values in the memory 150. In this case, the control unit 120 is not aware of change of values the pin 171 transmits, but recognizes an input of a specific value as error occurrence.

Although this embodiment uses a simple memory 150 composed of a four-bit address, it is exemplary only for simple illustration and not to be considered as a limitation of the present invention.

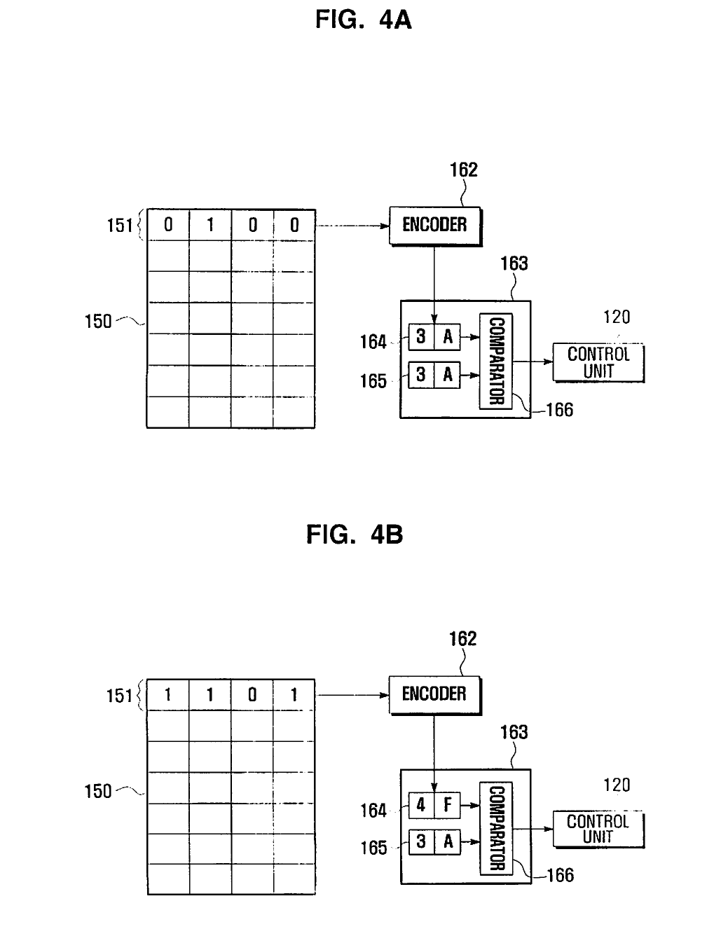

FIGS. 4A and 4B are schematic views that illustrate an apparatus and a method for detecting errors in a display driver IC of a mobile device in accordance with another exemplary embodiment of the present invention. FIG. 4A shows a normal state of the memory, and FIG. 4B shows an abnormal state of the memory.

Referring to FIG. 4A, the ID address 151 of the memory 150 is connected to an encoder 162. Additionally, although not shown, a register may be connected between the ID address 151 and the encoder 162 through a hard-wired line. The encoder 162 is connected to a discriminator 163, which includes a first embedded memory 164, a second embedded memory 165, and a comparator 166. The first and second embedded memories 164 and 165 are connected to the comparator 166, which is connected to the control unit 120 through the pin. The encoder 162 may be selectively connected to the first and second embedded memories 164 and 165.

The encoder 162 converts a series of bits recorded in the memory ID address 151 into a predefined code. Here, a code that the encoder 162 uses is one of the well-known codes for error detection, such as Cyclic Redundancy Check (CRC) code or Reed-Solomon (R-S) code. An encoded value outputted from the encoder 162 is stored in the first embedded memory 164. The second embedded memory 165 contains an encoded reference value regarding the same address 151. This encoded reference value has been already stored during the initialization process. The comparator 166 executes the comparison of two encoded values in the first and second embedded memories 164 and 165, and then transmits a comparison result to the control unit 120.

In the example shown in FIG. 4A, the memory ID address 151 records a series of bits ‘0100’ as the memory ID, which is encoded into ‘3A’ in the initialization process and stored in the second embedded memory 165. Thereafter, the encoder 162 synchronizes with a system clock and encodes the memory ID ‘0100’. Then an encoded value ‘3A’ is stored in the first embedded memory 164. The comparator 166 compares two encoded values stored in the first and second embedded memories 164 and 165. Since two encoded values agree with each other, the comparator 166 outputs a detection value (e.g., ‘1’) indicating a normal state. Then the detection value is loaded onto the pin and transmitted to the control unit 120.

When the memory ID in the memory ID address 151 is changed to another value (e.g., ‘1101’) as shown in FIG. 4B, the encoded value stored in the first embedded memory 164 is also changed to another value (e.g., ‘4F’). Since the two encoded values disagree with each other, the comparator 166 outputs another detection value (e.g., ‘0’). Therefore, the control unit 120 recognizes the change of the detection value through the pin and reinitializes the memory 150.

Like the earlier embodiment, this embodiment not only uses hard-wired lines for interconnections, but also uses interrupt instructions for error detection. It is therefore possible to improve a speed of error detection. In addition, this embodiment encodes all bits in the memory ID address 151 to detect errors. So, even if several bits have errors, it is possible to detect such errors at once.

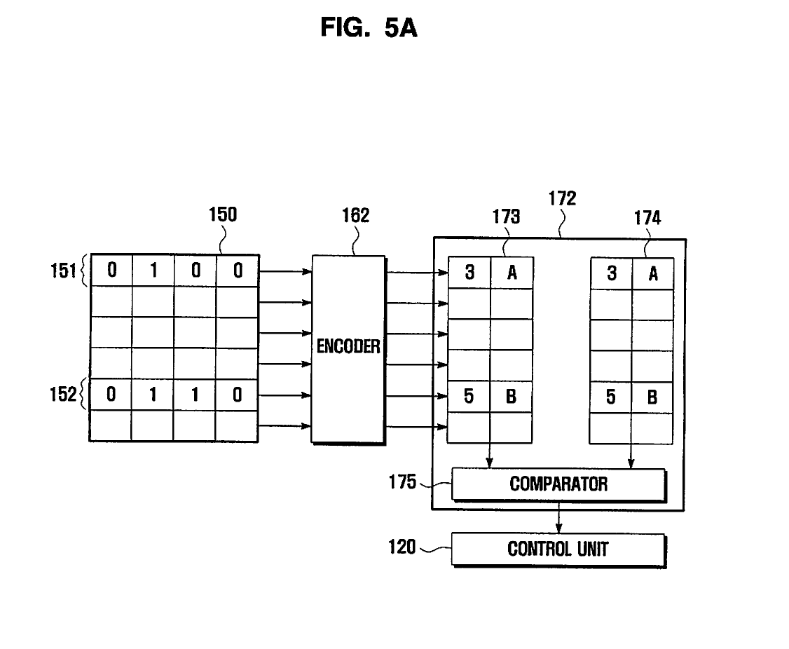

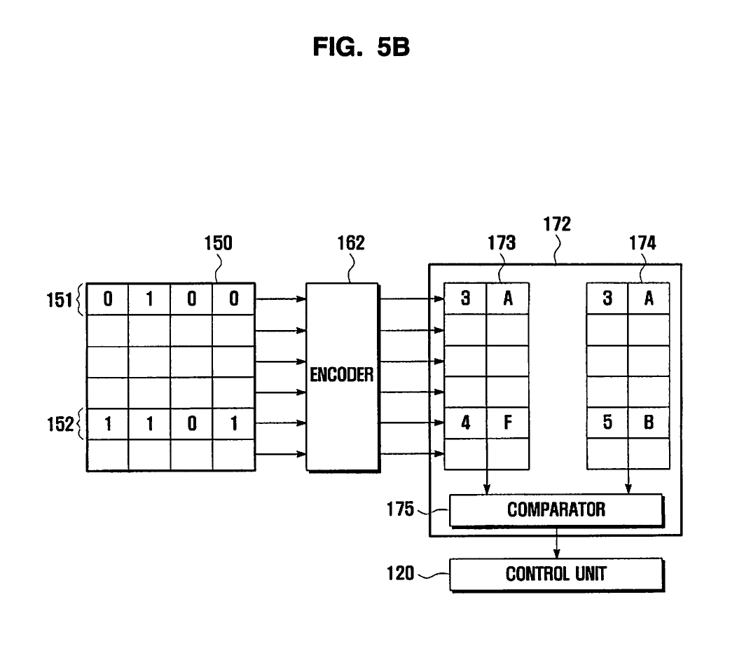

FIGS. 5A and 5B are schematic views that illustrate an apparatus and a method for detecting errors in a display driver IC of a mobile device in accordance with still another exemplary embodiment of the present invention. FIG. 5A shows a normal state of the memory, and FIG. 5B shows an abnormal state of the memory.

Referring to FIG. 5A, every address of the memory 150 is connected to the encoder 162. Each series of bits recorded in the respective addresses is encoded in the encoder 162 and then stored in the first embedded memory 164 of the discriminator 172. The comparator 175 executes the comparison of two encoded values in the first and second embedded memories 173 and 174, and then transmits a comparison result to the control unit 120.

In FIG. 5A, the memory ID address 151 records a series of bits ‘0100’ as the memory ID, and an example one 152 of other addresses recorded as a series of bits ‘0110’. The values in the respective addresses 151 and 152 are encoded into ‘3A’ and ‘5B’ in the initialization process and stored in the second embedded memory 174. Thereafter, the values in the respective addresses 151 and 152 are encoded and stored in the first embedded memory 173. The comparator 175 compares two encoded values stored in the corresponding first and second embedded memories 173 and 174 with respect to every address. If all corresponding pairs of values agree, the comparator 174 outputs a detection value (e.g., ‘1’) indicating a normal state. Then the detection value is loaded onto the pin and transmitted to the control unit 120.

When the value in the example address 152 is changed to another value (e.g., ‘1101’) as shown in FIG. 5B, the encoded value stored in the first embedded memory 173 is also changed to another value (e.g., ‘4F’). Since the values in the example address 152 disagree with each other, the comparator 175 outputs another detection value (e.g., ‘0’). Therefore, the control unit 120 recognizes the change of the detection value through the pin and reinitializes the memory 150.

Like the earlier described embodiments, this embodiment not only uses hard-wired lines for interconnections, but also uses interrupt instructions for error detection. It is therefore possible to improve a speed of error detection. In addition, this embodiment encodes all bits in every address to detect errors. So, even if any address in the memory has errors, it is possible to detect such errors immediately.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for detecting errors in a display driver integrated circuit of a mobile device, said apparatus comprising:
a memory storing control values for controlling a liquid crystal panel;
an error detector connected to the memory, the error detector checking the control values in the memory and outputting a detection value as a check result; and
a control unit connected to the error detector to receive the detection value from the error detector, the control unit executing a re-initialization process for the memory when the received detection value is unusual.

2. The apparatus of claim 1, wherein the memory and the error detector are included together within the display driver integrated circuit.

3. The apparatus of claim 1, wherein the memory and the error detector are connected through a hard-wired line.

4. The apparatus of claim 1, wherein the error detector and the control unit are connected through a pin on which the detection value is loaded.

5. The apparatus of claim 1, wherein the error detector includes an accumulator connected to a memory identification address of the memory, the accumulator calculating a sum of bits recorded in the memory identification address to output the sum as the detection value.

6. The apparatus of claim 5, wherein the accumulator has an inverter that maintains a uniform detection value regardless of the control values in the memory.

7. The apparatus of claim 1, wherein the error detector includes an encoder connected to a memory identification address of the memory, the encoder converting a series of bits recorded in the memory identification address into a predefined code to output the code as the detection value.

8. The apparatus of claim 7, wherein the error detector further includes first and second embedded memories selectively connected to the encoder, and a comparator connected to the first and second embedded memories, the first embedded memory storing the detection value, the second embedded memory storing a reference value, and the comparator comparing the detection value with the reference value and then transmitting a comparison result to the control unit.

9. The apparatus of claim 1, wherein the error detector includes an encoder connected to every address of the memory, the encoder converting a series of bits recorded in each address into a predefined code to output the code as the detection value.

10. The apparatus of claim 9, wherein the error detector further includes first and second embedded memories selectively connected to the encoder, and a comparator connected to the first and second embedded memories, the first embedded memory storing the detection value, the second embedded memory storing a reference value, and the comparator comparing the detection value with the reference value and then transmitting a comparison result to the control unit.

11. A method for detecting errors in a display driver integrated circuit of a mobile device, said method comprising:
initializing a memory of the display driver integrated circuit by storing control values in the memory for controlling a liquid crystal panel;
outputting a detection value depending on a change of the control values in the memory;
transmitting the detection value to a control unit; and
re-initializing the memory when the detection value is unusual.

12. The method of claim 11, wherein the transmitting of the detection value includes loading the detection value on a pin connected to the control unit.

13. The method of claim 11, wherein the outputting of the detection value includes calculating a sum of bits recorded in a memory identification address of the memory, and outputting the sum as the detection value.

14. The method of claim 13, wherein the outputting of the detection value further maintaining a uniform detection value regardless of the control values in the memory.

15. The method of claim 11, wherein the initializing of the memory includes storing a reference value regarding a memory identification address of the memory.

16. The method of claim 15, wherein the outputting of the detection value includes converting a series of bits recorded in the memory identification address into a predefined code, comparing the code with the reference value, and outputting a comparison result as the detection value.

17. The method of claim 11, wherein the initializing of the memory includes storing reference values regarding every address of the memory.

18. The method of claim 17, wherein the outputting of the detection value includes converting a series of bits recorded in each address into a predefined code, comparing each code with the corresponding reference value, and outputting a comparison result as the detection value.
